(19) United States
(12) Patent Application Publication
(10) Pub. No.: US 2019/0147426 A1
(43) Pub. Date: May 16, 2019

(54) PAIRING A MOBILE DEVICE WITH A MERCHANT TRANSACTION DEVICE

(71) Applicant: Walmart Apollo, LLC, Bentonville, AR (US)

(72) Inventors: Bradley J. Kieffer, Rogers, AR (US); Mark Matthews, Rogers, AR (US); Eytan Daniyalzade, San Francisco, CA (US); David Martin Nelms, Rogers, AR (US); Robert C. Taylor, Rogers, AR (US); Berk Atikoglu, San Francisco, CA (US); Charlie Berry, Fayetteville, AR (US)

(21) Appl. No.: 16/114,129

(22) Filed: Aug. 27, 2018

Related U.S. Application Data
(60) Provisional application No. 62/585,523, filed on Nov. 13, 2017.

(51) Int. Cl. G06Q 20/20; H04W 76/14; H04W 4/021; G06Q 20/32; H04M 1/725

(52) U.S. Cl. CPC G06Q 20/204; H04W 76/14; H04M 1/7253; G06Q 20/3224; G06Q 20/3278; H04W 4/021

(57) ABSTRACT

Examples provide pairing of a mobile electronic device with a merchant transaction device associated with a checkout area at a merchant facility. A plurality of advertising packets are received by the mobile electronic device. Each advertising packet of the plurality of advertising packets is associated with an individual beacon transceiver of a plurality of beacon transceivers. A checkout area of a plurality of checkout areas is identified within a beacon zone defined by an analysis of at least one parameter associated with the received advertising packets. A merchant pairing screen is generated at the mobile electronic device to pair the mobile electronic device to a merchant transaction device at the checkout lane of the plurality of checkout lanes. A pairing process for customer check-in to pick up an item is also provided in some examples.

### BACKGROUND

Today's mobile applications can have a wide variety of uses. Finding and accessing a specific feature in an application can be time consuming and frustrating. Sometime a user may not even know that a feature is available. For example, for a customer to use a mobile application during the checkout process in a store, the customer must know that the function is available and then how to access the function. Accordingly, the customer often does not use the function because the customer is either unaware that the function exists, or if the customer knows that the function is available, may not access the function because navigating to the function is a time consuming and/or complex process.

In a merchant setting, in many cases, because the function is not easily accessible, the customer is ready to make a payment to conclude a transaction before the function can be accessed. In other cases, the customer must manually perform additional confirmation operations using a mobile application to determine the register at which the customer is located. This is time consuming and many times the customer may not even receive complete instructions regarding how to perform the additional confirmation.

### SUMMARY

Examples of the disclosure provide a mobile electronic device that may be paired with a merchant transaction device. The mobile electronic device includes at least one processor and at least one memory having computer program code. The at least one memory and the computer program code are configured to, with the at least one processor, cause the mobile electronic device to detect a beacon generated by at least one beacon transceiver associated with one of a plurality of checkout areas at a merchant facility, the beacon including an embedded beacon code associated with the one of the plurality of checkout areas. The at least one memory and the computer program code are further configured to, with the at least one processor, cause the mobile electronic device to generate a merchant pairing screen at the mobile electronic device to pair the mobile electronic device to a merchant transaction device of the one of the plurality of checkout areas associated with the embedded beacon code, and issue a command to pair the mobile electronic device to the merchant transaction device.

Other examples provide one or more computer storage media having computer-executable instructions stored thereon for pairing of a mobile electronic device with a merchant transaction device at a checkout area at a merchant facility. The computer-executable instructions, upon execution by a processor, cause the processor to receive a plurality of advertising packets, wherein each advertising packet of the plurality of advertising packets is associated with an individual beacon transceiver of a plurality of beacon transceivers. The computer-executable instructions, upon execution by a processor, further cause the processor to identify a checkout area of a plurality of checkout areas within a beacon zone defined by an analysis of at least one parameter associated with the received advertising packets. The computer-executable instructions, upon execution by a processor, further cause the processor to generate a merchant pairing screen at the mobile electronic device to pair the mobile electronic device to a merchant transaction device at the checkout area of the plurality of checkout areas.

Still other examples provide a method for pairing of a mobile electronic device with a merchant transaction device associated with a checkout area at a merchant facility. The method includes receiving a plurality of advertising packets, wherein each advertising packet of the plurality of advertising packets is associated with an individual beacon transceiver of a plurality of beacon transceivers. The method further includes identifying a checkout area of a plurality of checkout areas within a beacon zone defined by an analysis of at least one parameter associated with the received advertising packets. The method also includes generating a merchant pairing screen at the mobile electronic device to pair the mobile electronic device to a merchant transaction device at the checkout area of the plurality of checkout areas.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for pairing a mobile device at a checkout area with a merchant transaction device.

FIG. 2 is another exemplary block diagram illustrating a system for pairing a mobile device at a checkout area with a merchant transaction device.

FIG. 3 is another exemplary block diagram illustrating a system for pairing a mobile device at a checkout area with a merchant transaction device.

FIG. 4 is an exemplary block diagram illustrating a computing device for pairing a mobile device at a checkout area with a merchant transaction device.

FIG. 5 is an exemplary flowchart illustrating operation of the computing device to pair a mobile device at a checkout area with a merchant transaction device.

Corresponding reference characters indicate corresponding parts throughout the drawings.

### DETAILED DESCRIPTION

Referring to the figures, examples of the disclosure enable receiving beacon data associated with pairing a mobile device to a specific checkout area (e.g., checkout lane or pick-up area) in a merchant facility and pairing the mobile device to a merchant transaction device (e.g., a merchant checkout or pick-up device) associated with the specific checkout area. In some examples, a merchant pairing screen is launched at a user mobile device for making a payment at a specific checkout lane at a merchant facility, or for picking up an item at a pick-up area, in response to a detected beacon signal associated with the specific checkout area. This process may be automatic and include launching a merchant-specific mobile application (e.g., a merchant-specific mobile payment application or a merchant-specific mobile pick-up application) into a checkout or pick-up mode upon arrival at a checkout area at the merchant facility. For example, upon detecting that a customer is at a checkout area, a merchant-specific mobile application (having a pairing screen) is automatically launched. The automatic launching of the pairing screen enables quick and efficient checkout and payment (and/or pick-up) at a merchant facility. This enables improved checkout efficiency and customer throughput.

In some examples, a detection is made that a customer (e.g., a shopper) is currently in a checkout area, and based on this detection, a notification is sent to a merchant-specific mobile application of a mobile device of the customer offering to take the customer directly to a payment function and/or a pick-up function. For example, Bluetooth® Low Energy (BLE) beacons may be used to emit advertising packets that the mobile application receives, even if the application is not currently running Upon receipt of the advertising packet, the merchant-specific mobile application is opened and, based on the location of the customer that has been identified from the received packet and optionally other indoor positioning system data (that allows for the determination of location of the user's mobile device running the application), the customer is presented with a notification asking the customer if he or she would like to proceed directly to the payment function and/or pick-up function within the merchant-specific mobile application.

In some examples, such as in a checkout lane application, the customer receives a reminder that payment through the merchant-specific mobile application is available, with the application opening to a screen that allows for initiation of the payment process, for example, a screen that allows for scanning of the QR code for payment (as additional verification of the customer's location). In other examples, the QR code scan is eliminated and the pairing of the customer's device (e.g., smartphone) with the merchant transaction device (which in this example if a merchant payment or checkout device), and registering for payment, are performed automatically based on the receipt of the BLE advertising packet. In some examples, virtual BLE beacons (rather than standalone BLE beacon hardware) may be used that can more precisely identify the location of the customer within the store, in which case the creation and scanning of the QR code may be eliminated.

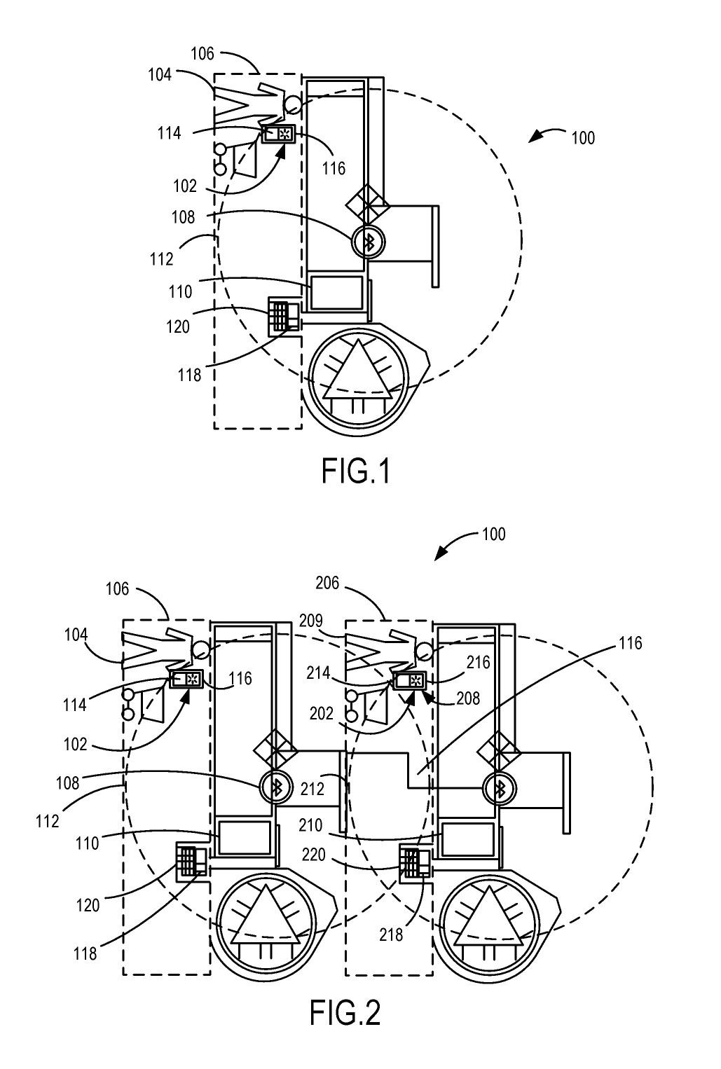

FIG. 1 illustrates a system 100 for pairing a mobile device 102 (e.g., a smartphone) of a user 104 (e.g., shopper or customer) with a merchant transaction device, which in this example is a merchant checkout device for checkout and payment of items. In the illustrated example, the mobile device 102 is paired with a specific checkout area, illustrated as a specific checkout lane 106 (e.g., paired with the merchant checkout device of that checkout lane during checkout and then is unpaired) in a merchant facility using received beacon data from a beacon 108 as described herein. For example, the user 104 with the mobile device 102 enters the checkout lane 106 for a register 110 equipped with the beacon 108. In one example, the beacon 108 is a Bluetooth® Low Energy (BLE) beacon that generates a radio signal that can be received within a beacon region 112. The beacon region 112 may be defined by the transmitting power of the beacon 108 and may encompass all or a part of the checkout lane 106, including regions located before, along and after the checkout lane 106. However, it should be appreciated that in some examples, the beacon region 112 is configured to encompass an area of the single checkout lane 106 and not any adjacent checkout lanes.

It should be appreciated that the described embodiments are not limited to use with a checkout lane 106, but as described herein, may be used in connection with any type of checkout area, including areas associated with item only pick-up (and returns), and in general, any transaction area within a merchant facility. Thus, it should be appreciated that the example described in FIG. 1 is merely for illustration and the various embodiments are not limited to use with a merchant checkout device, such as a merchant checkout device that processes payment for purchased items. For example, in some implementations, the merchant transaction device may be a device that does not process a merchant payment, but instead only processes a checkout functionality, such as for one or more items previously paid for and now being picked up. In some implementations, for example, a customer (such as the user 104) may come into a pickup area of the store and the various embodiments are used to “pair” the customer to a specific pickup station or lane (instead of a checkout lane 106). Thus, in this implementation, while the pairing operates to facilitate initiating a process with a merchant system, the pairing provides a check-in functionality to allow easier pickup of one or more items. In some instances, the customer will have previously paid for the item(s), while in other instances an additional payment function will also be initiated as described herein.

As used herein, the term “checkout” may include different transactions that occur at a merchant facility, which may or may not involve processing or payment. For example, a checkout process may include the scenario of check-in to pick up pre-ordered/purchased product, check-out of product through traditional lanes/kiosks, and product return scenarios, including pairing to transact product return at customer service or at a self-service kiosk. Thus, the checkout areas in various examples include, but are not limited to, a zone, and also self-service kiosks, customer service counters, and even mobile checkout areas (when associates walk around with handheld payment/checkout devices, they could have a beacon attachment that pairs with the device when in range). Thus, the various checkout areas may be any type of transaction area at a merchant facility, such as checkout lanes, counters, kiosks, mobile checkout areas, etc.

A mobile application 114 on the mobile device 102 is configured to listen for beacon information transmitted (e.g., broadcast) from the beacon 108. It should be appreciated that in some examples, the mobile application 114 is a merchant-specific mobile application that allows easier and more efficient access to merchant-specific transaction devices, such as to perform checkout, payment and/or pick-up functionality specific to a particular merchant. The merchant-specific mobile application may allow access to a retail store payment system or pick-up system to provide an easier and more automated process for payment or pick-up without having to select different options to access the features of the application.

In some examples, when the beacon is a BLE beacon, the mobile application 114 is configured to identify advertising packets emitted by the beacon 108 and received by the mobile device 102, such as based on a matching process that allows for identification of the advertising packets. In this example, communication (and the associated protocols) and packet identification may be performed using BLE standards and BLE communication technology for advertising packet transmission and reception. In operation, when the mobile device 102 detects an advertising packet from the beacon 108, the mobile device 102 is configured to automatically launch the mobile application 114, which, in some examples, begins a ranging task that determines when the mobile device 102 has entered the beacon region 112.

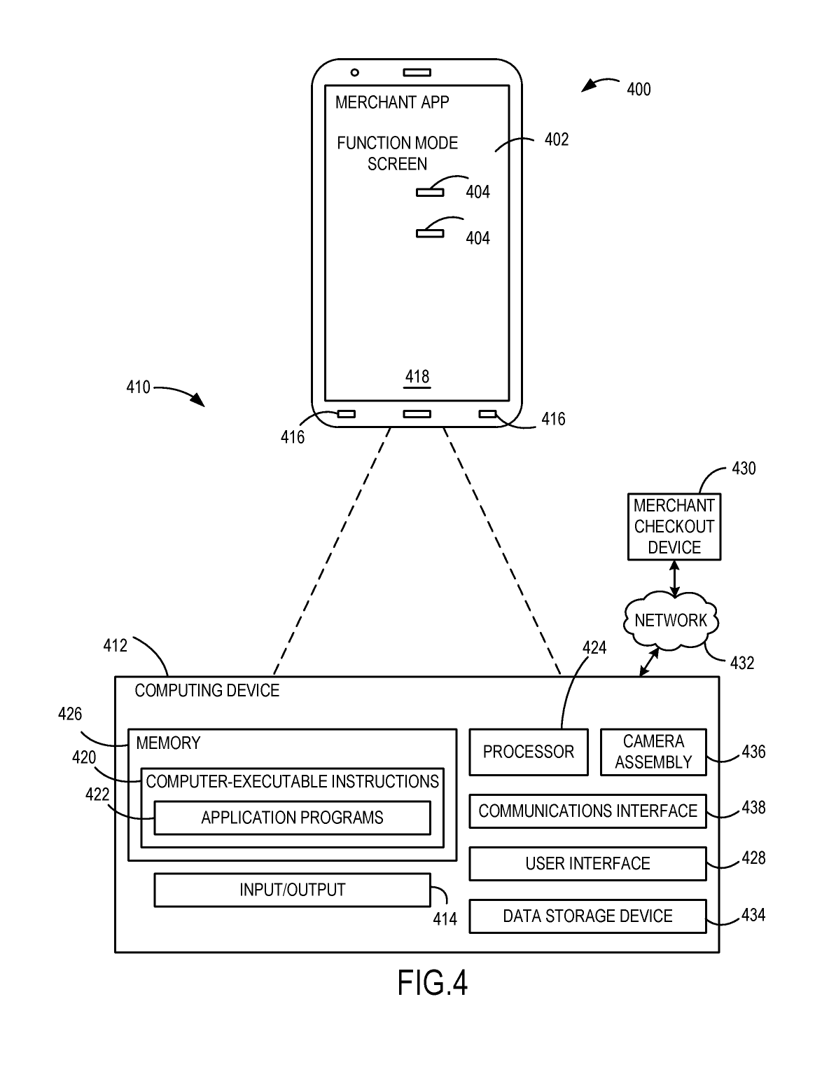

In some examples, once the mobile device 102 enters the beacon region 112, the mobile application 114 receiving the advertising packet from the beacon 108 has the mobile application 114 automatically launched to the foreground of the mobile device 102. In this initialization state, the mobile application 114 (e.g., a pairing screen of the mobile application 114 that is being displayed) prompts the user 104 to unlock the mobile device 102 (e.g., by entering a security passcode such as a Personal Identification Number (PIN) or through other means, such as a fingerprint reader or other biometric security feature), which will thereafter allow communication with a merchant checkout device. For example, as illustrated in FIG. 4, showing a smartphone 400, the mobile application 114 in some examples is configured to automatically navigate to a function mode once unlocked, which is accessible from a function mode screen 402 that presents different functions, such as different fields 404 (e.g., user input fields), illustrated as payment fields for processing payment as described herein. In other examples, the mobile application 114 is configured to navigate automatically to a particular function, such as the payment function (accessible from the function mode screen 402) immediately if the mobile device 102 is already unlocked and upon entry into the beacon region 112. In some examples, the mobile application 114 navigates to the function mode or a specific function, such as a payment function, based on a command within the advertising packet, which may include packet header information regarding the payment function. In other examples, the mobile application 114 recognizes the advertising packet as a trigger event that triggers a preconfigured navigation function, such as when the mobile application 114 is a merchant-specific mobile application.

It should be appreciated that the mobile application 114 may receive the navigation instruction in other forms or from other sources, as well as navigate to different functionality or screens, such as an item pickup screen that may provide check-in functionality as described herein. Thus, the mobile application may automatically navigate to an application function based on the received beacon packet. In one example, based on the advertising packet received, the mobile application 114 automatically launches payment functions (because the beacon is from a beacon associated with a checkout area). In another example, the mobile application 114 automatically launches transaction functions (such as product pick up, because the beacon is associated with a product pick-up kiosk/counter). In still another example, the mobile application 114 automatically launches product return function (because the beacon is from a beacon associated with a return counter, and the beacon sends a packet that instructs mobile application 114 to automatically launch the product return function).

In some examples, the connection of the mobile device 102 to the merchant checkout system involves another confirmation that the mobile device 102 is at the particular checkout lane 106. For example, the mobile application 114 may use a camera 116 on the mobile device 102 to scan a QR code 118 that in one example may be displayed adjacent to checkout lane 106, such as on a pin pad 120 that is linked to the register 110. In one configuration, the register 110 creates the QR code 118 for the transaction in process, and the mobile application 114 pairs to the merchant checkout system which grants access to stored payment information to the transaction to effect payment. It should be noted that the QR code 118 may be displayed at different areas or in different regions or by different components of the checkout lane 106. In one example, the QR code 118 is displayed on a payment screen of the pin pad 120 when the transaction total is displayed. As should be appreciated, the pin pad 120 may be any device capable of completing the payment transaction, and in some examples, includes a display portion and an input portion that allows user inputs (e.g., numeric inputs). Additionally, in some examples, the QR code 118 is displayed on different display or printouts generated at the checkout lane 106.

This additional confirmation is used, for example, when more than one checkout lane 106 is present and the beacon region 112 may overlap or otherwise encompass portions of other checkout lanes adjacent to or near checkout lane 106 (e.g., some portion of the checkout lane 106 may lie within the beacon region 112, some portion of the checkout lane 106 may reside outside the beacons region 112, and the beacon region 112 may encompass space that is outside of the checkout lane 106). Thus, to ensure that the mobile device 102 of the user 104 is properly linked (e.g., to confirm the checkout lane 106 at which the customer is located among multiple adjacently located checkout lanes 106), the user 104 may scan the QR code 118 with the camera 116 of the mobile device 102. It should also be noted that the systems and methods described herein may be implemented in connection with different checkout configurations. For example, the systems and methods may be implemented in connection with a checkout counter having multiple registers or in a configuration where checkout lanes 106 are arranged in different directions.

As should be appreciated, in some examples, the beacon 108 is installed near the checkout lane 106 (e.g., within or on a portion of the checkout lane 106) in order to detect the presence of the user 104 (e.g., when a customer enters the checkout region). With the beacon 108 located in close proximity to the most likely regions where the user 104 will be located along the checkout lane 106, once the user 104 is detected, the system 100 sends a notification request (e.g., notification/advertisement packets) regarding payment on the mobile device 102 and offering to take the user 104 directly to the payment function. For example, the regions where the user 104 will be located may include, without limitations, along a dedicated pathway associated with a checkout lane/area or a dedicated region associated with a pick-up or return counter, as required by the physical configuration of the checkout lane/area or pick-up or return counter. In some examples, the regions where the user 104 will be located are associated with the transaction device itself, such as in a mobile checkout area scenario.

As other example, the transaction device (e.g., checkout device) itself may send the beacon or have a dedicated beacon associated with the transaction device. For example, the beacon 108 may be embedded or communicatively coupled to the transaction device (e.g., the register 110).

Thus, by pairing the mobile device 102 with the merchant system (e.g., POS register) using a simple notification (e.g., BLE advertising packet), the user 104 is provided with easier and more efficient access to alternate payment options. In various examples, this access includes automatically presenting the user 104 with a notification asking the user 104 if he or she would like to proceed directly to the payment function within the mobile application 114. It should be noted that the mobile application 114 may be merchant-specific, payor-specific, etc.

Thus, the system 100 assists customers, such as the user 104 in performing transactions, such as checkout transactions at a retail store. It should be appreciated that other configurations may be implemented to detect the presence of the user 104 at the checkout lane 106. For example, different scanning or imaging devices may be used to detect entry of user in a geofence or monitored region.

In some embodiments, the mobile device 102 is configured with the capabilities to allow easier pairing with the merchant checkout device. For example, the mobile application 114 (which may be downloaded from a merchant website) may configure the mobile device 102 to detect a beacon generated by a transceiver of the beacon 108 located at the checkout lane 106 of the merchant facility (e.g., retail and/or grocery store). The mobile device 102 is configured such that the mobile device is able to receive and identify a transmitted beacon signal, which may include an embedded beacon code associated with the specific checkout lane 106. The mobile device 102 is, thus, configured to allow for a pairing arrangement, such as by generation of a merchant pairing screen (e.g., a merchant payment screen or a merchant item pickup check-in screen) at the mobile device 102 to pair the mobile device 102 to the merchant checkout device, such as register 110, of the checkout lane 106 associated with the embedded beacon code. In some examples, a command may be issued by the configured mobile device 102 to pair the mobile device 102 to the merchant checkout device. In some examples, a threshold time is defined during which the mobile device 102 is receiving the beacon signals before the merchant pairing screen launches. In one particular example, if the mobile device 102 passes a checkout area and detects the beacon signal once, but then not again after a threshold time, the mobile application 114 determines that the user 104 is not in a checkout mode (i.e., the user 104 is not standing in line waiting to checkout). But, if the mobile device 102 detects the signal again within the threshold time, then the decision is made to launch the pairing process.

The embedded beacon code can be configured differently, such as to have different values depending on a desired functionality or experience. For example, the embedded beacon code may be the following:
1. A code indicating that the user 104 is ‘in the checkout area—not a specific lane’ enables reminding the customer about the feature and/or launching the manual pairing feature (scan the QR code).
2. A code indicating the specific lane/transaction can enable automated pairing (once the user 104 approves via notification). This is useful when no de-conflicting (overlapping regions) is required.
3. A code indicating an identifier of the beacon itself (this is more likely in a virtual BLE scenario) where one or more received beacon codes are sent to a server/system that will determine where (e.g. which lane) the customer is located.

As described above, some examples include multiple checkout lanes 106. Such a configuration is illustrated in FIG. 2. It should be noted that parts in this figure are indicated as being similar to parts in FIG. 1 using a similar numbering convention. In particular, the elements 202, 206, 208, 210, 212, 214, 216 and 218 in FIG. 2 are similar to the elements 102, 104, 106, 108, 110, 112, 114, 116 and 118 in FIG. 1. It should be appreciated that in other examples, similarly, multiple checkout areas are provided, such as multiple pick-up locations as a pick-up counter.

As can be seen in FIG. 2, the beacon region 112 associated with the checkout lane 106 overlaps with the beacon region 212 of the checkout lane 206 at an overlap region 222. Thus, when the user 204 is within the overlap region 222, the system 100 may further determine whether the user 204 is located at the checkout lane 206 (which would be the proper lane identification) or is located at the checkout lane 206 (which is the improper lane identification, as the user 104 is located at the checkout lane 106 in this illustrative example). As described herein, some examples use the scanning of the QR code 118, 218 to confirm at which checkout lane 106, 206 the user 204 is located.

However, it should be appreciated that other confirmation techniques may be used as should be appreciated by those skilled in the art when reading the present disclosure and that the confirmation technique described is a non-limiting example. For example, different types of codes may be used instead of QR codes. As another example, the system 100 may determine which beacon 208 is detecting one user 204 and which beacon 108 is detecting two users 104, 204 and discriminate between these two to identify the user 204 as being located at the checkout lane 206. For example, in one example, if two beacons 108, 208 both detect one user 204, but only one of the two beacons (in this example, beacon 208) detects a second user 204, then it is determined that the first user 104 is within the range of the checkout lane 106 associated with the beacon 108 detecting both users 104, 204, while the second user 204 is in the checkout lane 206 of the beacon 208 that only detects the second user 204.

It should be noted that this discrimination could also be used if a user 104, 204 was not present at one of the checkout lanes 106, 206. As still another technique, other proximity scanners or sensors may be used to detect the presence of the user 104, 204. As should be appreciated, these techniques can be extended to additional checkout lanes when present. Additionally, when a checkout lane 106, 206 is closed, in some examples, the beacon 108, 208 associated with that checkout lane 106, 206 is turned off (when the corresponding register 110, 210 is turned off or logged out).

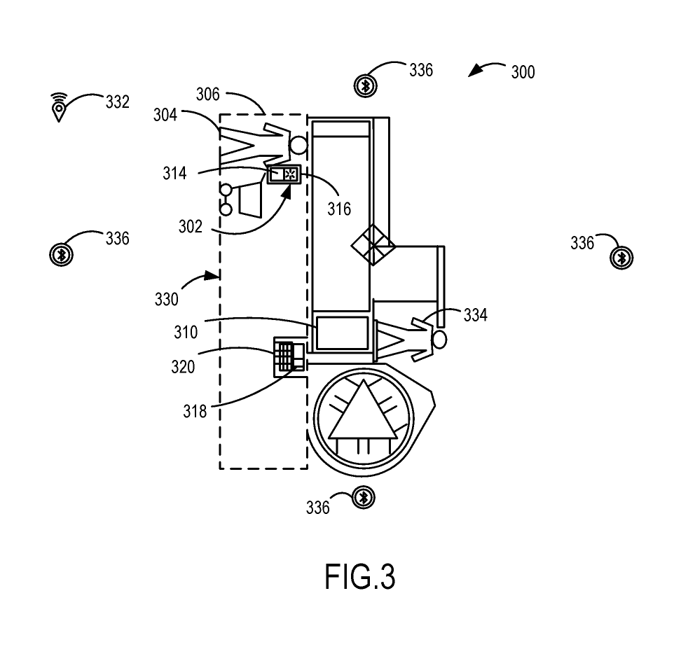

Variations and modifications are contemplated. For example, instead of using the beacons 108, 208, which are configured as standalone beacons that are used for determining user proximity to the checkout lane 106, 206, detection devices that provide virtual detection within the merchant facility may be provided as illustrated in FIG. 3. It should be noted that parts in this figure are indicated as being similar to parts in FIGS. 1 and 2 using a similar numbering convention. In particular, the elements 302, 304, 306, 310, 314, 316, 318 and 320 in FIG. 3 are similar to the elements 102, 104, 106, 110, 114, 116, 118 and 120 in FIG. 1 and the elements 202, 206, 210, 214, 216, 218 and 220 in FIG. 2.

In FIG. 3, a system 300 uses beacons 336 to detect a user 304. In one example, the beacons 336 are configured to use Virtual Bluetooth® Low Energy (vBLE) technology. As can be seen, the user 304 with a user device 302 (e.g., smartphone) enters the checkout lane 306 for the register 310. Different from other examples described herein, the system 300 includes a plurality, for example an array, of the beacons 336, which are configured as vBLE transceivers. The beacons 336 are arranged within the merchant facility at locations to provide a density to enable a more precise indoor positioning for the mobile device 302. In this example, the mobile device 302 includes a mobile application 314 that is also enabled by Real Time Location System (RTLS) 332. The RTLS 332 is configured to “cast” a beacon region 330 using the beacons 336 (having the vBLE Transceivers) that highly correlates to the checkout lane 306 (e.g., is shaped to have a boundary similar to the checkout lane 306 and the immediately surrounding region). More particularly, the system 300 defines a beacon region 330 that can encompass only the single checkout lane 306 without encompassing other checkout lanes (such as illustrated in FIG. 2). Thus, in this example, a further confirmation, such as with a QR code may not be needed as the user 304 can be precisely located at the checkout lane 306. Thus, a camera 316 of the user device 302 does not need to be used to scan any codes. However, the additional confirmation may be performed in some examples.

In this example, the mobile application 314 is configured to listen for advertising packets matching those being emitted by vBLE transceivers of the beacons 336. When the mobile device 302 detects an advertising packet from the vBLE transceivers of the beacons 336, the mobile device 302 launches the mobile application 314 to receive location updates from the RTLS 332 based on calculations from signals received from the vBLE transceivers of the beacons 336. Once the mobile application 314 (through the RTLS 332) determines that the mobile device 302 has entered the beacon region 330, the mobile application 314 prompts the user 304 to unlock the mobile device 302, again either by entering a security passcode such as a Personal Identification Number (PIN) or through other means, such as a fingerprint reader or other biometric security feature on user device 302. The mobile application 314 is configured to navigate automatically to a payment function once unlocked, or immediately if the user device 302 was already unlocked, upon entry into the beacon region 330 as described in more detail herein. It should be noted that the processes for locating the mobile device 302 and performing the pairing and payment process may be provided by the mobile application 314, which may be a single application with different functionality or different applications.

However, as should be appreciated, confirmation or validation of the user 304 may optionally be performed in the example of FIG. 3. For example, the mobile application 314 can be configured to use the camera 316 on the mobile device 302 to scan a QR code 318 displayed on a pin pad 320 that is linked to the register 310. The register 310 in some examples creates the QR code 318 for the transaction in process, and the mobile application 314 is configured to pair to the merchant checkout system which grants access to stored payment information to the transaction in process at register 310 to effect payment as described herein.

In another example, the RTLS 332 interfaces with the register 310 and other systems (as needed) to determine when the transaction for the user 304 is beginning (e.g., a first item of the user 304 to be purchased has been scanned at the register 310 by either the user 304 or a cashier 334, which may be determined from a corresponding indication in the merchant checkout system that is communicated to the mobile application 314). In this example, rather than relying on the scanning of the QR code 318, the mobile application 314 prompts the user 304 of mobile device 302 to pair the mobile application 314 with the register 310 based on the location of mobile device 302 in the beacon region 330. This process allows each item being scanned to be displayed by the mobile application 314, along with additional information, such as the running total of the transaction. Once all items have been scanned, the user is prompted by the mobile application 314 for payment.

As should be appreciated, using vBLE allows, with a single device, implementation of multiple virtual beacons, which have the same effect as deploying a grid/array of physical beacons. With more beacons and utilizing signal strength, the system 300 can achieve a more accurate location. In one example, the mobile device 302 communicates all the beacons that the mobile device 302 is “hearing” to a server, which knows the beacon locations and uses this information to determine the location of the mobile device 302, which is communicated to the mobile application 314.

Parameters for one or more components may be varied as desired or needed. For example, the range for the beacons 108, 208 may be several inches (e.g., 1-6 inches) or several feet (e.g., 1-5 feet). In one configuration, a user 104, 204 may hold or pass the mobile device 102, 202 near the beacon 108, 208 to trigger the application 114, 214. In some examples, such triggering may invoke a confirmation request to be displayed at the mobile device 102, 202 that provides the user 104, 204 with a prompt to confirm a checkout lane location. In this way, the triggering avoids any “wrong lane” problems because there is no overlap.

With particular reference now to FIG. 4, a block diagram shows an operating configuration 410 that is illustrated as the smartphone 400. The smartphone 400 illustrates display of the function mode screen 402 that presents different functions, such as the different fields 404 (e.g., user input fields), which may be payment fields for processing payment as described herein, or other fields to effect checkout or pick-up as described herein. In some examples, the function mode screen 402 may be a page that is launched based on the identified beacon and/or received advertising packet. The operating configuration 410 is operable to employ techniques described herein. The operating configuration 410 may be an example of a computing device 412 that is physically and communicatively coupled to an input/output component 414. The computing device 412 may be configured in a variety of ways. For example, the computing device 412 may be configured for mobile use, such as a mobile phone as illustrated, a tablet computer, and so on. Thus, the computing device 412 may range from full resource devices with substantial memory and processor resources to a low-resource device with limited memory and/or processing resources. Additionally, the computing device may represent a group of processing units or other computing devices. The computing device 412 may also relate to software that causes the computing device 412 to perform one or more operations.

In one example, the computing device 412 includes an input/output component 414. The input/output component 414 is representative of functionality relating to processing of inputs and rendering outputs of the computing device 412, such as an input requesting pairing to a merchant transaction device, such as a merchant checkout device to effect a payment or a merchant pick-up device to effect product pick-up. In some examples, the function mode screen is a payment screen displayed to present different payment fields.

A variety of different inputs may be processed by the input/output component 414, such as inputs relating to functions that correspond to buttons 416 of the smartphone 400, keys of a virtual keyboard displayed by a display device 418 to identify gestures and cause operations to be performed that correspond to the gestures that may be recognized through the input/output component 414 and/or touchscreen functionality of the display device 418, and so forth. Thus, the input/output component 414 may support a variety of different input techniques by recognizing and leveraging a division between types of inputs including key presses, gestures, and so on.

In the illustrated example, the input/output component 414 is configured as having an input portion that is operable primarily using virtual inputs, although other arrangements are also contemplated. Thus, the input/output component 414 and keys may assume a variety of different configurations to support a variety of different functionality.

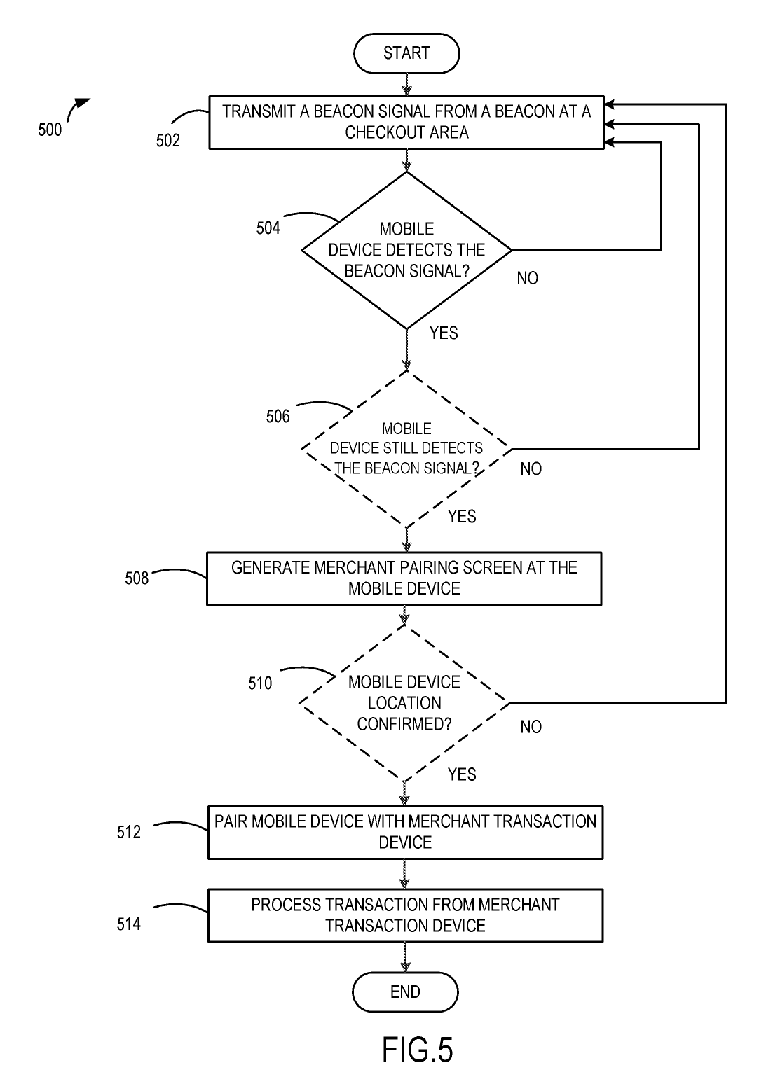

The computing device 412 represents any device executing computer-executable instructions 420 (e.g., as application programs 422, operating system functionality, or both) to implement the operations and functionality associated with the computing device 412. In some examples, the computing device 412 has at least one processor 424, a memory 426, and at least one user interface component 428. The processor 424 includes any quantity of processing units, and is programmed to execute the computer-executable instructions 420. The computer-executable instructions 420 may be performed by the processor 424 or by multiple processors within the computing device 412, or performed by a processor external to the computing device 412. In some examples, the processor 424 is programmed to execute instructions such as those illustrated in the figures (e.g., FIG. 5) or perform processes as described in the figures (e.g., FIGS. 1-3).

In some examples, the processor 424 represents an implementation of analog techniques to perform the operations described herein. For example, the operations may be performed by an analog computing device and/or a digital computing device.

The computing device 412 further has one or more computer-readable media such as the memory 426. The memory 426 includes any quantity of media associated with or accessible by the computing device 412. The memory 426 may be internal to the computing device 412 (as shown in FIG. 4), external to the computing device 412 (not shown), or both (not shown). In some examples, the memory 426 includes read-only memory and/or memory wired into an analog computing device.

The memory 426 stores data, such as one or more applications, such as the application programs 422, which may be embodied as the mobile applications 114, 214, 314 (illustrated in FIGS. 1-3). The applications, when executed by the processor 424, operate to perform functionality on the computing device 412. The applications may communicate with counterpart applications or services such as a merchant checkout device 430 via a network 432. For example, the applications may allow for automatic initiation of a payment process when the smartphone 400 is detected at the checkout lane 106, 206, 306 (shown in FIGS. 1-3) and completion of the payment transaction via the merchant checkout device 430.

Payment information (e.g., accepted payment sources) may be retrieved from a data storage device or a remote data source, such as a cloud server or a remote database accessible via the network 432. The network 432 is implemented by one or more physical network components, such as, but without limitation, routers, switches, network interface cards (NICs), and other network devices. The network 432 may be any type of network for enabling communications with remote computing devices, such as, but not limited to, a local area network (LAN), a subnet, a wide area network (WAN), a wireless (Wi-Fi) network, or any other type of network. In this example, the network 432 is a WAN accessible to the public, such as the Internet.

In the illustrated example, one or more data storage devices, such as, but not limited to, a data storage device 434 store data, such as related to the location of the smartphone 400 and payment information for completing the payment transaction (such as a preferred payment source), among other data. In other examples, one or more sensor(s) may be provided. In one example, resource data is retrieved from the data storage device 434 using scan data received from a scanning device, such as from a camera assembly 436 that acquires QR code information. As described herein, the user 104, 204, 304 (shown in FIGS. 1-3) in some examples scans a QR code to confirm the location of the user 104, 204, 304 at a checkout lane 106, 206, 306 (shown in FIGS. 1-3).

In some examples, the computing device 412 includes a communications interface component 438. The communications interface component 438 includes a network interface and/or computer-executable instructions (e.g., a driver) for operating the network interface. Communication between the computing device 412 and other devices may occur using any protocol or mechanism over any wired or wireless connection.

The user interface component 428 may also include one or more of the following to provide data to a user or receive data from a user associated with the computing device 412: speakers, a sound component, a microphone, a vibration motor, one or more accelerometers, a Bluetooth® communication module, GPS hardware, and a photoreceptive light sensor.

FIG. 5 is an exemplary flowchart illustrating operation for pairing a mobile electronic device with a merchant checkout device, such as at a checkout lane at a merchant facility. The process 500 shown in FIG. 5 may be performed by different components executing on a computing device, such as, but not limited to, the computing device 412 in FIG. 4. It should be noted that one or more of the operations in the process 500 may be changed or removed, as well as more operations added. The one or more operations may be performed more than once and in a different order than illustrated. Additionally, one or more operations may be performed simultaneously, concurrently or sequentially.

The process 500 begins by a beacon transmitting a signal at a checkout area (e.g., a checkout lane or pick-up counter) at operation 502. For example, a physical beacon (such as a BLE beacon at each checkout lane) or virtual beacons may broadcast a beacon signal periodically in order to detect when a shopper or customer is at the checkout lane (and accordingly is ready to checkout and pay) or whether the customer is ready to check-in to pick up an item, which may or may not include payment for the item (e.g., the customer may have already paid for the item in the store (for layaway) or online for store pickup). In some embodiments, the beacon transmission includes transmitting a beacon signal with a beacon code embedded therein, or transmitting a plurality of advertising packets. In some examples, each advertising packet of a plurality of advertising packets is associated with an individual beacon transceiver of a plurality of beacon transceivers (corresponding to each of the checkout lanes).

A determination is made whether a mobile device detects the beacon signal at operation 504. For example, a mobile device (e.g., a smartphone) may detect that the beacon signal has been transmitted and received by the mobile device when the mobile device is within a beacon region of the beacon. The determination may include identifying a checkout lane within a beacon region or zone defined by an analysis of at least one parameter associated with the received advertising packets to identify the checkout lane or pick-up counter at which the mobile device is located. In some examples, a communication channel is established between the RTLS application at the mobile device and the RTLS in response to receiving at least one of the plurality of advertising packets. Mobile device location updates may also be received at the RTLS application from the RTLS based on the analysis of at least one parameter associated with the received advertising packets performed at the RTLS.

If no mobile devices are within the beacon region as determined at the operation at 504, such that no mobile device detects the beacon signal, then the process returns to operation 502 to continuing transmitting beacon signals. If a mobile device is within the beacon region, such that a mobile device detects the beacon signal at operation 504, a determination then optionally may continue to be made at 506, whether the mobile device still detects the beacon signal. For example, a threshold time may be defined during which the mobile device is receiving the beacon signals before the merchant pairing screen launches. In a checkout scenario, if the mobile device passes a checkout lane and detects the beacon signal once, but then not again after a threshold time, the mobile application determines that the user is not in a checkout mode (i.e., the user is not standing in line waiting to checkout) and the process returns to operation 502. But, if the mobile device detects the signal again within the threshold time, then the decision is made to launch the pairing process at operation 508.

Specifically, at operation 508, a merchant pairing screen is generated at the mobile device. For example, as described herein, a function mode application may be launched that can include a merchant pairing screen and/or a check-in screen that is generated at the mobile device and used to pair the mobile device to the merchant transaction device, such as a register of the checkout lane associated with the embedded beacon code (i.e., the checkout lane where the beacon is located that transmitted the beacon signal) or a pick-up lane or counter location where the beacon is located. In some examples, a determination of whether the mobile device has been enabled to make a payment at the merchant facility is made before the merchant pairing screen is generated and displayed at the mobile device.

Additionally, in some examples, a query is issued to a merchant server regarding the embedded beacon code in the detected beacon. The pairing screen is then generated at operation 508 when a response is received from the merchant server (e.g., a code specific to the particular merchant checkout device to which the mobile device is to be paired) that the embedded beacon code is associated with a launching of the merchant pairing screen (associated with making a payment at checkout lane and/or picking up an item at a pickup area of a store). In some examples, a push notification is issued at the mobile device regarding a launching of the merchant pairing screen to pair the mobile electronic device with the merchant checkout device at the lane associated with the beacon code embedded in the detected beacon. A user command may also be received via a user input device of the mobile device in response to the push notification, which results in the pairing screen being launched.

The location of the mobile device is optionally confirmed at operation 510. For example, in a configuration that includes multiple adjacently located checkout lanes, confirmation may be used when a mobile device is within an overlap region of two beacon regions as described herein. In some examples, the confirmation may include scanning a QR code with the camera of the mobile device to confirm the checkout lane at which the mobile device is located. However, in some examples, confirmation is not used.

When the operation 510 is performed, if the mobile device location is not confirmed, then the process 500 returns to operation 502 and the beacon signal is again transmitted. If the mobile device location is confirmed at operation 510, then the mobile device is paired with a merchant transaction device (e.g., merchant checkout, payment and/or pick-up device) at operation 512. For example, a command may be issued to pair the mobile device to the merchant transaction device (e.g., using wireless communication airing protocols). In one example, the merchant pairing screen is generated at the mobile device to pair the mobile electronic device to the merchant checkout device of the checkout lane associated with the embedded beacon code.

The process 500 also includes initiating a transaction, such as a payment processing from the merchant transaction device at operation 514, such as to pay for one or more products purchased from the merchant facility. In some examples, the payment may include selecting a stored payment method for use in paying for the product(s). When operating in an RTLS environment, a message from the RTLS also may be used by the RTLS application to identify when a transaction at the checkout lane has been initiated. In some examples, a check-in process is initiated to pick up one or more items before payment if payment is still needed when a customer is picking up an item. In some examples, payment may have been already made and only the check-in process is initiated.

Once the transaction processing, such as the payment processing, is complete and/or the mobile device is no longer at the checkout lane (e.g., no longer detected by the beacon), or item pickup is complete, the mobile application unpairs the mobile device from the merchant checkout device. In some examples, the mobile device is unpaired (pairing is terminated) from the merchant checkout device after a predetermined time period, which may be defined from the start of the pairing or upon completion of the payment transaction.

While the operations illustrated in FIG. 5 are performed by a mobile device or other computing device, aspects of the disclosure contemplate performance of the operations by other entities. For example, a cloud service may perform one or more of the operations.

### Additional Examples

A mobile electronic device that pairs with a merchant transaction device is provided in one example. The mobile electronic device includes at least one processor and at least one memory including computer program code. The at least one memory and the computer program code are configured to, with the at least one processor, cause the mobile electronic device to detect a beacon generated by at least one beacon transceiver associated with one of a plurality of checkout areas at a merchant facility, wherein the beacon includes an embedded beacon code associated with the one of the plurality of checkout areas. The at least one memory and the computer program code are further configured to, with the at least one processor, cause the mobile electronic device to generate a merchant pairing screen at the mobile electronic device to pair the mobile electronic device to a merchant transaction device of the one of the plurality of checkout areas associated with the embedded beacon code, and issue a command to pair the mobile electronic device to the merchant transaction device.

In another example, one or more computer storage media having computer-executable instructions stored thereon for pairing of a mobile electronic device with a merchant transaction device at a checkout area at a merchant facility are provided. The computer-executable instructions, upon execution by a processor, cause the processor to receive a plurality of advertising packets, each advertising packet of the plurality of advertising packets being associated with an individual beacon transceiver of a plurality of beacon transceivers. The computer-executable instructions, upon execution by a processor, further cause the processor to identify a checkout area of a plurality of checkout areas within a beacon zone defined by an analysis of at least one parameter associated with the received advertising packets. The computer-executable instructions, upon execution by a processor, further cause the processor to generate a merchant pairing screen at the mobile electronic device to pair the mobile electronic device to a merchant transaction device at the checkout area of the plurality of checkout areas.

In another example, a method for pairing of a mobile electronic device with a merchant transaction device associated with a checkout area at a merchant facility is provided. The method includes receiving a plurality of advertising packets, each advertising packet of the plurality of advertising packets being associated with an individual beacon transceiver of a plurality of beacon transceivers. The method also includes identifying a checkout area of a plurality of checkout areas within a beacon zone defined by an analysis of at least one parameter associated with the received advertising packets. The method further includes generating a merchant pairing screen at the mobile electronic device to pair the mobile electronic device to a merchant transaction device at the checkout area of the plurality of checkout areas.

In some examples, the beacon is a Bluetooth® Low Energy beacon.

Alternatively, or in addition to the other examples described herein, examples include a combination of the following:
generating the merchant pairing screen at the mobile electronic device to pair the mobile electronic device to the merchant transaction device of the one of the plurality of checkout areas associated with the embedded beacon code;
issuing a command to pair the mobile electronic device to the merchant transaction device and to display a merchant pairing screen on a display of the mobile electronic device;
issuing a query to a merchant server regarding the embedded beacon code in the detected beacon; and receiving a response from the merchant server that the embedded beacon code is associated with a launching of the merchant pairing;
issuing a push notification at the mobile electronic device regarding a launching of the merchant pairing screen to pair with the mobile electronic device with the merchant checkout device at the one of the plurality of checkout areas associated with the beacon code embedded in the detected beacon;
receiving a user command via a user input device of the mobile electronic device in response to the push notification, and launching the merchant pairing screen in response to the received user command;
determining whether the mobile electronic device has been enabled to make a payment at the merchant facility, and generating the merchant pairing screen if the mobile electronic device has been enabled to make a payment at the merchant facility;
receiving a plurality of advertising packets, each advertising packet of the plurality of advertising packets being associated with an individual beacon transceiver of a plurality of beacon transceivers, identifying a checkout area of a plurality of checkout areas within a beacon zone defined by an analysis of at least one parameter associated with the received advertising packets, and generating a merchant pairing screen at the mobile electronic device to pair the mobile electronic device to a merchant transaction device at the checkout area of the plurality of checkout areas;
issuing a command to pair the mobile electronic device to the merchant transaction device, wherein the plurality of checkout areas comprise at least one of a checkout lane, a pick-up counter, a self-service kiosk, a customer service counter and a mobile checkout area;
a merchant application that issues a query to a merchant server regarding the embedded beacon code in the detected beacon and receives a response from the merchant server that the embedded beacon code is associated with a launching of the merchant pairing screen associated with making a payment at the one of the plurality of checkout areas;
a merchant application that issues a push notification at the mobile electronic device regarding a launching of the merchant pairing screen to pair with the mobile electronic device with the merchant transaction device at the one of the plurality of checkout areas associated with the beacon code embedded in the detected beacon;
receiving a user command via a user input device of the mobile electronic device in response to the push notification and launching the merchant pairing screen in response to the received user command;
determining whether the mobile electronic device has been enabled to make a payment at the merchant facility and generating the merchant pairing screen if the mobile electronic device has been enabled to make a payment at the merchant facility;
issuing a command to pair the mobile electronic device to the merchant transaction device;
establishing a communication channel between an RTLS application at the mobile electronic device and an RTLS in response to receiving at least one of the plurality of advertising packets, receiving electronic mobile device location updates at the RTLS application from the RTLS based on the analysis of the at least one parameter associated with the received advertising packets performed at the RTLS, and identifying the beacon zone that the electronic mobile device is located within;
determining whether the mobile electronic device has been enabled to make a payment at the merchant facility and generating the merchant pairing screen if the mobile electronic device has been enabled to make a payment at the merchant facility;
establishing a communication channel between a RTLS application at the mobile electronic device and a RTLS in response to receiving at least one of the plurality of advertising packets and receiving a message from the RTLS at the RTLS application that a transaction at the one of the plurality of checkout areas has been initiated; and
wherein the message from the RTLS that the transaction has been initiated at the one of the plurality of checkout areas is based on the RTLS receiving a message from the merchant transaction device that the transaction has been initiated.

At least a portion of the functionality of the various elements in FIG. 1, FIG. 2, FIG. 3, FIG. 4, and FIG. 5 may be performed by other elements in FIG. 1, FIG. 2, FIG. 3, FIG. 4, and FIG. 5, or an entity (e.g., processor, web service, server, application program, computing device, etc.) not shown in FIG. 1, FIG. 2, FIG. 3, FIG. 4 or FIG. 5.

In some examples, the operations illustrated in FIG. 5 may be implemented as software instructions encoded on a computer-readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of computing systems, environments, and/or configurations that may be suitable for use with aspects of the examples include, but are not limited to, mobile computing devices, personal computers, server computers, hand-held or laptop devices, multiprocessor systems, microprocessor-based systems, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for customized resource-related task allocation. For example, the elements illustrated in FIG. 1, FIG. 2, FIG. 3, and FIG. 4 such as when encoded to perform the operations illustrated in FIG. 5 constitute exemplary means for pairing a mobile device with a merchant transaction device.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A mobile electronic device comprising:
at least one processor; and
at least one memory comprising computer program code, the at least one memory and the computer program code configured to, with the at least one processor, cause the mobile electronic device to:
detect a beacon generated by at least one beacon transceiver associated with one of a plurality of checkout areas at a merchant facility, the beacon including an embedded beacon code associated with the one of the plurality of areas lanes;
generate a merchant pairing screen at the mobile electronic device to pair the mobile electronic device to a merchant transaction device of the one of the plurality of checkout areas associated with the embedded beacon code; and
issue a command to pair the mobile electronic device to the merchant transaction device.

2. The mobile electronic device of claim 1, wherein the beacon is a Bluetooth® Low Energy beacon.

3. The mobile electronic device of claim 1, further comprising a merchant application stored at the at least one memory and the at least one processor causes the merchant application at the mobile electronic device to:
generate the merchant pairing screen at the mobile electronic device to pair the mobile electronic device to the merchant transaction device of the one of the plurality of checkout lanes associated with the embedded beacon code; and
issue a command to pair the mobile electronic device to the merchant transaction device and to display the merchant pairing screen on a display of the mobile electronic device.

4. The mobile electronic device of claim 1, wherein the checkout areas are checkout lanes and further comprising a merchant application stored at the at least one memory and the at least one processor causes the merchant application at the mobile electronic device to:
issue a query to a merchant server regarding the embedded beacon code in the detected beacon; and
receive a response from the merchant server that the embedded beacon code is associated with a launching of the merchant pairing screen associated with making a payment at the one of the plurality of checkout lanes.

5. The mobile electronic device of claim 1, further comprising a merchant application stored at the at least one memory and the at least one processor causes the merchant application at the mobile electronic device to:
issue a push notification at the mobile electronic device regarding a launching of the merchant pairing screen to pair with the mobile electronic device with the merchant transaction device at the one of the plurality of checkout lanes associated with the beacon code embedded in the detected beacon.

6. The mobile electronic device of claim 5, wherein the at least one processor causes the merchant application at the mobile electronic device to:
receive a user command via a user input device of the mobile electronic device in response to the push notification; and
launch the merchant pairing screen in response to the received user command.

7. The mobile electronic device of claim 1, wherein the at least one processor causes the mobile electronic device to:
determine whether the mobile electronic device has been enabled to make a payment at the merchant facility; and
generate the merchant pairing screen if the mobile electronic device has been enabled to make a payment at the merchant facility.

8. One or more computer storage media having computer-executable instructions stored thereon for pairing of a mobile electronic device with a merchant transaction device at a checkout area at a merchant facility, that, upon execution by a processor, cause the processor to:
receive a plurality of advertising packets, each advertising packet of the plurality of advertising packets being associated with an individual beacon transceiver of a plurality of beacon transceivers;
identify a checkout area of a plurality of checkout areas within a beacon zone defined by an analysis of at least one parameter associated with the received advertising packets; and
generate a merchant pairing screen at the mobile electronic device to pair the mobile electronic device to a merchant transaction device at the checkout area of the plurality of checkout areas.

9. The one or more computer storage media of claim 8, further comprising:
issuing a command to pair the mobile electronic device to the merchant transaction device, wherein the plurality of checkout areas comprise at least one of a checkout lane, a pick-up counter, a self-service kiosk, a customer service counter and a mobile checkout area.

10. The one or more computer storage media of claim 8, wherein the plurality of beacon transceivers are virtual Bluetooth® Low Energy beacon transceivers.

11. The one or more computer storage media of claim 8, wherein identifying a checkout area of a plurality of checkout areas within a beacon zone defined by an analysis of at least one parameter associated with the received advertising packets comprises:
establishing a communication channel between a Real Time Location System application at the mobile electronic device and a Real Time Location System in response to receiving at least one of the plurality of advertising packets;
receiving electronic mobile device location updates at the Real Time Location System application from the Real Time Location System based on the analysis of the at least one parameter associated with the received advertising packets performed at the Real Time Location System; and
identifying the beacon zone that the electronic mobile device is located within.

12. The one or more computer storage media of claim 8, further comprising:
determining whether the mobile electronic device has been enabled to make a payment at the merchant facility; and
generating the merchant pairing screen if the mobile electronic device has been enabled to make a payment at the merchant facility.

13. The one or more computer storage media of claim 8, further comprising:
establishing a communication channel between a Real Time Location System application at the mobile electronic device and a Real Time Location System in response to receiving at least one of the plurality of advertising packets; and
receiving a message from the Real Time Location System at the Real Time Location System application that a transaction at the one of the plurality of checkout areas has been initiated.

14. The one or more computer storage media of claim 12, wherein the message from the Real Time Location System that the transaction has been initiated at the one of the plurality of checkout lanes is based on the Real Time Location System receiving a message from the merchant transaction device that the transaction has been initiated.

15. A method for pairing of a mobile electronic device with a merchant transaction device associated with a checkout area at a merchant facility, the method comprising:
receiving a plurality of advertising packets, each advertising packet of the plurality of advertising packets being associated with an individual beacon transceiver of a plurality of beacon transceivers;
identifying a checkout area of a plurality of checkout areas within a beacon zone defined by an analysis of at least one parameter associated with the received advertising packets; and
generating a merchant pairing screen at the mobile electronic device to pair the mobile electronic device to a merchant transaction device at the checkout area of the plurality of checkout areas.

16. The method of claim 15, further comprising:
issuing a command to pair the mobile electronic device to the merchant transaction device, wherein the plurality of checkout areas comprise at least one of a checkout lane, a pick-up counter, a self-service kiosk, a customer service counter and a mobile checkout area.

17. The method of claim 15, wherein the plurality of beacon transceivers are virtual Bluetooth Low Energy beacon transceivers.

18. The method of claim 15, wherein identifying a checkout area of a plurality of checkout areas within a beacon zone defined by an analysis of at least one parameter associated with the received advertising packets comprises:
establishing a communication channel between a Real Time Location System application at the mobile electronic device and a Real Time Location System in response to receiving at least one of the plurality of advertising packets;
receiving electronic mobile device location updates at the Real Time Location System application from the Real Time Location System based on the analysis of the at least one parameter associated with the received advertising packets performed at the Real Time Location System; and
identifying the beacon zone that the electronic mobile device is located within.

19. The method of claim 15, further comprising:
determining whether the mobile electronic device has been enabled to make a payment at the merchant facility; and
generating the merchant pairing screen if the mobile electronic device has been enabled to make a payment at the merchant facility.

20. The method of claim 15, further comprising:
establishing a communication channel between a Real Time Location System application at the mobile electronic device and a Real Time Location System in response to receiving at least one of the plurality of advertising packets; and
receiving a message from the Real Time Location System at the Real Time Location System application that a transaction at the one of the plurality of checkout areas has been initiated.
